(19) United States
(12) Patent Application Publication
(10) Pub. No.: US 2022/0172203 A1
(43) Pub. Date: Jun. 2, 2022

(54) BLOCKCHAIN-SECURED REPOSITORY THAT AUTHENTICATES ACTIONS BETWEEN MUTUALLY UNSECURE ENTITIES

(71) Applicant: TrustClarity, Inc., Chicago, IL (US)

(72) Inventor: Haran Sujeevan Jeganathan, Chicago, IL (US)

(21) Appl. No.: 17/456,185

(22) Filed: Nov. 23, 2021

Related U.S. Application Data
(60) Provisional application No. 63/119,118, filed on Nov. 30, 2020.

(51) Int. Cl. G06Q 20/38; G06Q 20/40

(52) U.S. Cl. CPC G06Q 20/38215; G06Q 20/4014; G06Q 20/3827

(57) ABSTRACT

Introduced here is a blockchain-secured repository that authenticates actions between mutually unsecured entities. In particular, the blockchain-secured repository stores origination data indicative of actions involving particular objects. By doing so, the repository enables secured interaction between unsecured parties by comparing origination details to subsequent reproductions of the origination details of each action. Additionally, the repository compares origination data with reproductions of the data prior to the reproduction becoming public. If the reproduced data contradicts the original data, the reproduced data is prevented from becoming public. The unsecured parties can also store data indicative of the origination terms between the unsecured parties in the blockchain-secured repository. Thus, the repository can objectively automate the processing of the terms. The purpose of the blockchain-secured repository is to provide a data-based approach to authenticating actions between unsecured parties.

### CROSS-REFERENCE TO RELATED APPLICATIONS

This application claims the benefit of U.S. Provisional Application No. 63/119,118 filed Nov. 30, 2020, the content of which is hereby incorporated in its entirety.

### TECHNICAL FIELD

The disclosed teachings relate to providing a blockchain-secured repository. More particularly, the disclosed teachings relate to providing a blockchain-secured repository that authenticates actions between mutually unsecure entities.

### BACKGROUND

Large corporations regularly purchase products in bulk and with long lead times. This is partially due to manufacturers requiring a high minimum order number and the time it takes to manufacture products. The market for global electronic components is approximately $370 billion in 2019. In certain industries, such as cable and telecom, companies order excess products valuing between of $500,000 to $300 million. In another example, repair centers have excess purchases valued between $200,000 and $100 million per company.

The excess ordering is caused due to complexity of the product marketplace, long lead times, high minimum order quantities, and inaccurate forecasting. In addition to the extra money spent, the excess products are often discarded at an alarming rate. For instance, 2 billon tons of e-waste are produced globally every year with only 13% being recycled and 5% composted.

### BRIEF DESCRIPTION OF THE DRAWINGS

FIG. 1 illustrates a network 100 of interconnected peer nodes 102-1 through 102-6 (also referred to collectively as peer nodes 102 and individually as peer node 102).

FIG. 2 is a block diagram that illustrates a system that can track the authentication details of resale products.

FIG. 3 is a block diagram that illustrates locations 300 of authentication data used to determine the authenticity of excess products.

FIG. 4 is a block diagram of an environment in which the disclosed embodiments can be implemented.

FIGS. 5A-D illustrate exemplary user interfaces for making an offer to purchase a resale product.

FIGS. 6A-C illustrate exemplary user interfaces from the seller's perspective to respond to an offer.

FIGS. 7A-B illustrate exemplary resell feature user interfaces embedded within a 3rd party platform.

FIG. 8 is a block diagram that illustrates an example of a processing system in which at least some operations described herein can be implemented.

### DETAILED DESCRIPTION

Corporations regularly order products in bulk from manufacturers months in advance, based on a forecast because manufacturers require long lead times. Additionally, corporations are generally forced to order in bulk because many manufacturers require a high minimum order number. As such, corporations are often left with excess products. These excess products can amount to millions of dollars of loss.

To mitigate the loss, some corporations rely on a resale market. Currently, there are two primary resale markets: broker-dealers and online resale websites. Broker-dealers are third party sales companies that routinely contact the corporations to offer to resell their excess products in exchange for a portion of the sale price. After an agreement is reached, the broker-dealers then find a buyer using similar methods and negotiate the exchange of the excess products. The buyer makes the purchase based on trusting all the parties involved. The trust can be developed based on prior interactions, the corporation involved, or proof of provenance. For example, the corporation that is reselling products might be Comcast. The buyer, due to familiarity with Comcast and trusting that a large corporation would not be selling fraudulent products, can buy the products with additional comfort and trust. Moreover, the buyer may trust the broker-dealer to perform reasonable checks to verify the authenticity of the products, based again, on prior interactions or positive history of the broker-dealer.

Another option is using online resale websites such as eBay or Amazon. On these websites, the corporations or the broker-dealer can post a listing for the excess products. The listing can include pictures of the products, specifications of the products, the current location, and ratings of the seller. The information regarding the products can be inputted by the seller and the ratings can be based on reviews by previous customers. For example, a particular seller can have a four star review out of five stars. The online marketplace can, for example, determine the star rating based on an average of the stars given by the past buyers.

This original buyer to reseller to resale buyer eco-system causes many issues. First, the requirements by the original manufacture force corporations into spending in excess. For example, a corporation with a history of selling one thousand widgets may still be forced to order five thousand widgets because that is the minimum order number for the manufacturer of the widget. Subsequently, the corporation must rely on the resale market to recoup some of the losses. In another example, a corporation may forecast a need for five thousand widgets, but the forecast may become too optimistic due to economic conditions. Thus, again, the corporation must rely on the resale market to recoup losses.

Second, by having to order the minimum order number, corporations produce unnecessary waste. Further to the example above, the corporation can have up to four thousand widgets in excess. In the resale market, an additional two thousand widgets may be sold. Even after mitigating the loss, the corporation is left with two thousand widgets in excess. The excess inventory is then often discarded, if not used within a reasonable amount of time due to inventory holding costs, shelf space and accounting benefits.

Third, the long lead times and high minimum order requirements push smaller corporations out of the market. For example, large corporations with a large credit line, large profit margin, and a lengthy history in the market, is more likely to be able to make large orders with a reasonably reliable forecast. In other words, large corporations can bear the risk of such a large transaction. Conversely, smaller or start-up corporations with small profit margins, and less reliable forecasting methods are less likely to be able to make such orders. Thus, these companies may struggle to find original products and may have to rely on the resale market. This causes further issues because smaller startups will struggle to be one of the first in the market because the larger corporations will likely sell their excess after the market has been saturated. Also, in contrast to larger, more heavily profitable corporations, unintentional or excess inventory orders can have a material, and sometime catastrophic impact to small business if not handled properly.

Fourth, the resale market can be easily exploited. Namely, the resellers can sell fraudulent products to the buyer. For example, a reseller can list on an online marketplace an offer to resell scratch resistant encasing for a cable modem box manufactured for Comcast. The reseller may specify in the listing that the box is made of scratch resistance material and the reseller may have positive reviews. Based on this information, a buyer may feel that the risk is low, and make the order. However, the buyer is not present with concrete proof of the box has the qualities listed in the offer for sale. In other words, the buyer must perform a risk analysis based on the information that is posted to eventually get to a point where the buyer is comfortable taking on the risk. However, every aspect the listing can be manipulated. For example, the reseller may have posted the positive reviews themselves or posted false information regarding the product. For instance, the box may not be scratch proof or manufactured for Comcast. It could merely a box made to imitate the scratch proof box made for Comcast.

Due to these and other issues with the current state of the product-ordering business, there is a need for a reliable, objective, and accurate resale market for excess products.

Introduced is a blockchain-based business to business marketplace for selling new products and enabling easy reselling of excess purchased products. The sustainable platform is a new product and excess inventory marketplace solution, that enables manufacturers, service providers, distributors, repair centers, manufacturer representatives, and broker dealers to sell products to their customers, and help broker and monetize on the re-sale any excess products their customers may have purchased. For example, similar to the way national online ticketing websites have a single platform to help sports teams to sell and buyers to re-sell their purchased tickets for an event, the marketplace is a single platform that will help manufacturers, service providers, distributors, repair centers, manufacturer representatives, and broker dealers to have a portal or website to help sell their products and assist their buyers with brokering the re-sale of excess or unused purchased inventory; thereby, extending the life of a product and keeping it out of the waste stream. Using Distributed Ledger Technology (Blockchain), it enables all the product listings to have security settings at the data level, enabling the ability to for listing to be simultaneously visible on multiple sites.

The platform can be a dedicated platform or portal for selling products and enabling the brokerage and reselling of excess purchased products. The product and the details needed to verify the authenticity of the product can be collected and stored in a tamper-proof distributed ledger. Implementing a private blockchain enables immutable asset tracking from the origin, accountability, and trust in the global buy and sell marketplace of specialized components and excess products. Thus, a buyer of excess product can verify the details in an offer for sale through the details on the distributed ledger, thereby; preventing the need to take on the risk of the product being fraudulent in some way.

With a blockchain based resale enabled marketplace, as described herein, there are several advantages: easily reselling excess components or products that were ordered to the same market of new buyers, providing a layer of insurance, reduced risk, and confidence to buyers; buyers gaining easy access to excess components or products immediately, without long lead times of new product orders; manufacturers ability to track the resale, custody chain, and downstream use of authentic components; manufacturer, buyer and reseller monetizing on resale of excess spare parts, providing the discovery of a new revenue or cost recovery stream; reducing the exchange of counterfeit components; enhanced visibility to the resale market; reduced excess inventory storage; and most importantly reduced electronic waste and generally avoidable waste moving to landfill

The resale enabled marketplace can also provide a medium for original buyers to resell products that were bought from an original product manufacturer through the online marketplace platform or customer portal. For example, an original buyer of products can enter the online marketplace select a model of the product of interest, choose the part type, purchase the part, and also later resell the excess at a later time within the same platform or portal they purchased the inventory from.

The details on the distributed ledger can be logged at every stage of the product. For example, for a wireless antenna, there may be three vital components: the hardware, the cabling, and the encasing. Manufacturer A can purchase these components from other manufacturers of these products and subsequently, build the wireless antenna. The distributed ledger can track the sale and purchase of the hardware, the cabling, and the encasing from the individual manufacturers to the manufacturer A. After building the wireless antenna, manufacturer A can sell the finished product to buyer. Again, the distributed ledger can log this transaction. Thus, when the buyer decides to resell these products, due to an excess order, resale buyer can verify the product details.

The product details can include provenance of product and its components, the sale and purchase contracts between the manufacturer and original buyer, the locations that the product traveled through, the serial numbers of the product and components, and other details needed to verify the authenticity of the product. Moreover, the details can be logged by participants in the life cycle of a product. For example, the buyer can log the details of the bulk order in the distributed ledger. The buyer is incentivized to do so because it increases the potential of attracting resale buyers. The details can be logged periodically or upon the occurrence of an event that affects the condition of the products.

By storing these and other details in a distributed ledger, the challenges of obtaining reliable data are eliminated. Namely, the disclosed embodiments use the distributed ledger as a immutable, trustworthy, and secure data repository where details regarding a product is logged. The disclosed technology can be used to log the details of any products or anything else where the authenticity of the object dictates the resale market.

### Use Case Examples

In the status quo, a supply chain is fragmented. In addition to an already faulty supply chain, the challenges of the Internet and Internet of Things enabled technology (e.g., sensors, RFID, drones, digital manufacturing products), there is a perpetual risk of counterfeiting and security breaches. Safeguarding against such risk can stretch the abilities of a supply chain database to a breaking point and thus, threaten the integrity of the entire supply chain.

Accordingly, a blockchain based supply chain is a natural next step in view of the issues discussed above. For example, a Fluree based blockchain can make transactions on the supply chain visible, traceable, and immutable. In other words, Fluree enables trust in the supply chain.

In particular, Fluree enables traceability of changes that are tied to digital signatures, including third-party applications that operate between clients and data. Fluree timestamps the data blocks and logs each block via cryptography (e.g., hashing). Fluree also enables visibility across participants by providing a single source of data to be stored, queried, and transacted on the blockchain.

As applied to the online resale enabled marketplace described herein, Fluree can provide provenance, immutability, improved listings, improved security, and an improved platform. Provenance provides traceability of a product to its origin or earliest recorded history with product transaction history logging and tracking as the product moves from customer to customer. Immutability is the inability to delete a record or transaction and ensure controls against tampering of the records. Immutability is especially important in a multi-participant environment where there are multiple unknown and untrusted parties. For example, immutability can prevent resellers from selling more than they have historically purchased. Moreover, the listings are improved with more accurate descriptions that are preserved for future re-listings. The security at the transaction layers is improved by enabling listing on multiple channels and sites. Additionally, the improved platform (e.g., Web 3.0 ) enable smart contracts can enable equal and fair payouts to multiple downstream participants based on agreed upon payouts per established contracts that are approved in the system.

In the resale enabled marketplace ecosystem, there are multiple participants: manufacturers, original buyers, service providers, distributors, repair centers, manufacturer representatives, and broker dealer. In the telecom industry, for example, a manufacture can be Technicolor, an original buyer can be Comcast, and broker dealer can be CATV Services. For instance, Technicolor can manufacture a cable box that is purchased by Comcast. Comcast can purchase 100,000 cable boxes, on the Technicolor's resale enabled marketplace portal, based on the Technicolor's minimum order number and based on Comcasts forecasting of future demand. At later time and after receiving the 100,000 cable boxes, Comcast may realize that they have an excess of 25,000 cable boxes.

By using the resale enabled marketplace described herein, Comcast can list for resale the excess cable boxes on the same Technicolor's resale enabled marketplace portal that was used to purchase the original boxes. A broker dealer (e.g., resale buyer) at CATV Services, who has a demand for these cable boxes, went to the Technicolor's resale enabled marketplace portal, and can see the resale listing and validate the provenance (e.g., transaction history, history of custody, locations, price history). With the added trust and visibility, the broker dealer can purchase the excess cable boxes with little risk.

In another example, Company A can buy 100,000 modem boxes from Manufacturer A. In this case, Company A is a trusted partner of Manufacturer A due to a long history of transactions. After receiving the 100,000 units, Company A can realize that they do not have a need for the 100,000 units and thus, have an excess of 100,000 modem boxes. However, Company A decides to list, for resale, 200,000 modem boxes on the resale enabled marketplace, even though they only purchased 100,000.

Due to the immutability of the resale enabled marketplace, which contains a record of all transactions, the marketplace/platform/portal would prevent Company A from listing more units than were purchased. Additionally, the marketplace can also prevent Company A from using other underhanded techniques (e.g., bribery, manipulation of records) to enable the fraudulent listing.

In yet another example, Company A can purchase 100,000 antennas from Manufacturer A via Manufacturer A's resale enabled marketplace portal. Company A can then realize that they have an excess of 25,000 antennas. Thus, they can list, for resale, the excess antennas on Manufacture A's resale enabled marketplace portal. When Company A attempts to post the listing, the marketplace checks the transaction history to find the details (e.g., specification, description, version, photos, product data) that was included in the original order. The marketplace then uses these same details in the resale listing. As such when Resale Buyer A is looking for the antennas, the details match the original posting. Thus, Resale Buyer A has trust in the accuracy of the relisting and can purchase the excess with reduced risk.

In some embodiments, the marketplace ecosystem can enable sales or resales of products from participants in various industries (e.g., medical, automotive, semiconductor, telecom, fashion, agricultural, or natural resources). The marketplace can, for example, partition products by industry, permit access to third-parties based on their industry, and/or store data in separate containers based on the industry. For example, marketplace can include industry A, B, and C. Manufacturer A can be a participant in Industry A, and thus, the marketplace can permit Manufacturer A to list products for sale/resale only in the Industry A container. Moreover, buyer B can be a broker-dealer in industry B. Thus, buyer B can access the listings associated with industry B in the marketplace. In other words, the marketplace can be partitioned based on industry such that a participant can access only the products related to their industry (e.g., based on participant selection or prior history).

In some embodiments, the marketplace can function in a hierarchical manner. For example, the marketplace can be the parent node of a multi-tiered ecosystem with multiple sub-nodes. For instance, the marketplace can have a relationship where a manufacturer representative (e.g., parent node) can post products for sale/resale with ten companies (e.g., sub-nodes). In this instance, the posting or listing made on a sub-node, could be made visible or managed on the parent node, provided permission is authorized to do so by both parties. Moreover, each of the ten companies may have relationships with two distributors. Thus, in some cases, listings that are purchased and then later listed for resale by the distributors on a sub-node marketplace and can then subsequently automatically be made visible on the parent node's marketplace, based on permission being granted. By enabling a hierarchical ecosystem, the marketplace can function as a repository for down-stream participants in each aspect of a product life cycle.

In another example, Reseller A, B, C, and D can be categorized in the marketplace as “Authorized Resellers”. Company A can purchase new antennas from Manufacturer A's resale enabled marketplace portal, and later realizes that Company A has excess antenna stock. Company A then tries to resell the excess antennas on the Manufacturer A's same resale enabled marketplace portal. Company A can elect to have the listing available and visible on all “Authorized Reseller” sites. Thus, Resale Buyer A can view the listing on any of Reseller A, B, C, and D's websites. All the posting can include the same details that are supplied by the distributed ledger.

In another example, Broker Dealer A gets into an agreement with Original Buyer A to resell Original Buyer A's excess products for a 15% commission. All of Original Buyer A's excess products will be listed on Broker Dealer A's resale enabled marketplace portal. When setting up the excess inventory listings in the portal, Broker Dealer A permits all “Authorized Resellers” resale enabled marketplace portals to have access to list any excess products from Original Buyer A. As such, All of Original Buyer A's inventory will also be available, and optionally visible, for listing on any resale enabled marketplace portal that is categorized as a “Authorized Resellers” site. The “Authorized Resellers” and Broker Dealer A can individually or collectively have a smart contract in place that routes a 5% finders fee commission on all sales made on the “Authorized Reseller's” Portal on behalf of Broker Dealer A's listed products. On approval of this smart contract, the Original Buyer A's listings (via Broker Dealer A's listings) are made available on all approved “Authorized Resellers” Resale enabled Portals. The sales can be of any products listed by Broker Dealer A and associated companies (e.g., Original Buyer A). Further, due to these agreements, Resale Buyer A can buy Original Buyer A's excess products on the “Authorized Resellers” resale enabled marketplace portal for $100,000. As such, 5%, $5,000, is automatically routed to the Authorized Resellers marketplace, 10%, $10,000, can be routed to Broker Dealer A and $85,000 can go to Original Buyer A. In some embodiments, payments between parties can occur in other methods such as an ACH transfer. Accordingly, storing contract on the distributed ledger enable quick transactions, with limited risk of fraudulent behavior.

### Distributed Ledger

In layman's terms, a digital distributed ledger stores digital records of things such as transactions that are distributed and maintained among nodes of a computer network, where the entries are stored in blocks of the ledger that are cryptographically related. A public blockchain is a common example of a distributed ledger that can record transactions between parties in a verifiable and permanent way. Specifically, a blockchain system has a decentralized, distributed database where a ledger is maintained by peer nodes. Hence, an intermediary is not required to maintain a blockchain. The transactions are typically authenticated with cryptographic hashing and mining techniques.

A blockchain is analogous to a distributed database on a distributed computing system that maintains a continuously growing list of ordered records called blocks. A block of a blockchain includes records of transaction(s) or other recorded data (e.g., provenance data, serial number). Each block contains at least one timestamp, and a block links to a previous block to thus form a chain of blocks. Blockchains are inherently resistant to modification of their recorded data. That is, once recorded, the data in a block cannot be altered retroactively. Through a peer network and distributed timestamping, a blockchain is managed in an autonomous manner.

Decentralized consensus can be achieved with a blockchain. This makes blockchains suitable for recording events, sale records, other records such as management activities, identity management, transaction processing, and proving data provenance. Well-known examples of decentralized systems that implement blockchains include Bitcoin and Ethereum cryptocurrencies. These types of systems provide a pragmatic solution for arriving at a consensus in the face of trust and timing problems typically encountered in distributed networks.

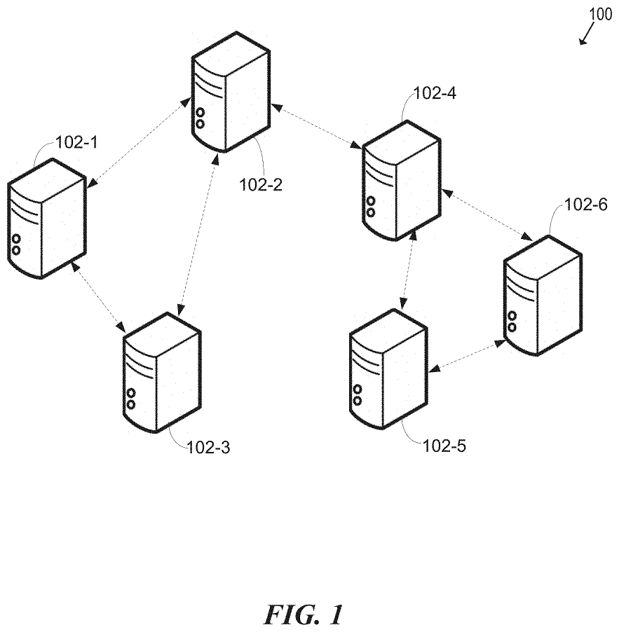

FIG. 1 illustrates a network 100 of interconnected peer nodes 102-1 through 102-6 (also referred to collectively as peer nodes 102 and individually as peer node 102). The peer nodes 102 can be distributed across various geographic locations including regions all over the world. The network 100 can include a combination of private, public, wired, or wireless portions. Data communicated over the network 100 can be encrypted or unencrypted at various locations or portions of the network 100. Each peer node 102 can include combinations of hardware and/or software to process data, perform functions, communicate over the network 100, and the like.

The peer nodes 102 can include computing devices such as servers, desktop or laptop computers (e.g., APPLE MACBOOK, LENOVO 440), handheld mobile devices (e.g., APPLE IPHONE, SAMSUNG GALAXY), and any other electronic device. Any component of the network 100 can include a processor, memory or storage, a network transceiver, a display, operating system and application software (e.g., for providing a user interface), and the like. Other components, hardware, and/or software included in the network 100 that are well known to persons skilled in the art are not shown or discussed herein for the sake of brevity.

The network 100 can implement a blockchain that allows for the secure management of a shared ledger, where transactions are verified and stored on the network 100 without a governing central authority. Blockchains can be implemented in different configurations, ranging from public, open-source networks, to private blockchains that require explicit permission to read or write transactions. Central to a blockchain are cryptographic hash functions that secure the network 100, in addition to enabling transactions, to protect a blockchain's integrity and anonymity.

The network 100 can utilize cryptography to securely process data. For example, public-key cryptography uses asymmetric key algorithms, where a key used by one party to perform either encryption or decryption is not the same as the key used by another in the counterpart operation. Each party has a pair of cryptographic keys: a public encryption key and a private decryption key. For example, a key pair used for digital signatures consists of a private signing key and a public verification key. The public key can be widely distributed, while the private key is known only to its proprietor. The keys are related mathematically, but the parameters are chosen so that calculating the private key from the public key is unfeasible. Moreover, the keys could be expressed in various formats, including hexadecimal format.

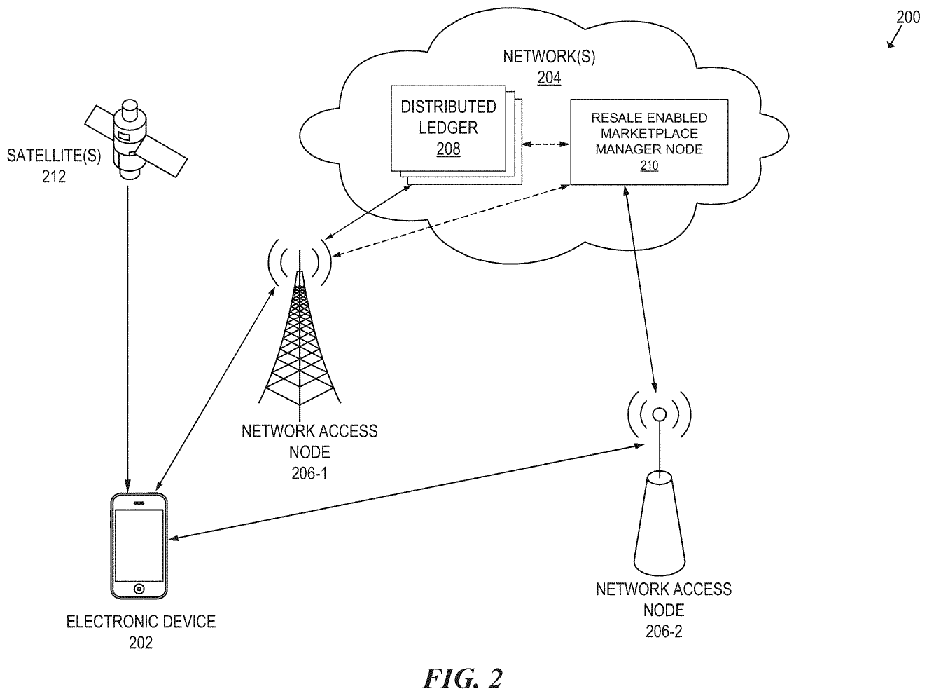

FIG. 2 is a block diagram that illustrates a system that can track the authentication details of new and resale products. The system 200 includes an electronic device 202 that is communicatively coupled to one or more networks 204 via network access nodes 206-1 and 206-2 (referred to collectively as network access nodes 206).

The electronic device 202 is any type of electronic device that can communicate wirelessly with a network node and/or with another electronic device in a cellular, computer, and/or mobile communications system. Examples of the electronic device 202 includes smartphones (e.g., APPLE IPHONE, SAMSUNG GALAXY), tablet computers (e.g., APPLE IPAD, SAMSUNG NOTE, AMAZON FIRE, MICROSOFT SURFACE), personal computers, enterprise servers, wireless devices capable of machine-to-machine (M2M) communication, wearable electronic devices, movable Internet of Things devices (IoT devices), and any other handheld device that is capable of accessing the network(s) 204. Although only one electronic device 202 is illustrated in FIG. 2, the disclosed embodiments can include any number of electronic devices.

The electronic device 202 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The electronic device 202 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more busses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 206 can be any type of radio network node that can communicate with a wireless device (e.g., electronic device 202) and/or with another network node. The network access nodes 206 can be a network device or apparatus. Examples of network access nodes include a base station (e.g., network access node 206-1), an access point (e.g., network access node 206-2), or any other type of network node such as a network controller, radio network controller (RNC), base station controller (BSC), a relay, transmission points, and the like.

The system 200 depicts different types of wireless access nodes 206 to illustrate that the electronic device 202 can access different types of networks through different types of network access nodes. For example, a base station (e.g., the network access node 206-1) can provide access to a cellular telecommunications system of the network(s) 204. An access point (e.g., the network access node 206-2) is a transceiver that provides access to a computer system of the network(s) 204. The network(s) 204 can include any combination of private, public, wired, or wireless systems such as a cellular network, a computer network, the Internet, and the like. Any data communicated over the network(s) 204 can be encrypted or unencrypted at various locations or along different portions of the networks. Examples of wireless systems include Wideband Code Division Multiple Access (WCDMA), High Speed Packet Access (HSPA), Wi-Fi, Wireless Local Area Network (WLAN), and Global System for Mobile Communications (GSM), GSM Enhanced Data Rates for Global Evolution (EDGE) Radio Access Network (GERAN), 4G or 5G wireless wide area networks (WWAN), and other systems that can also benefit from exploiting the scope of this disclosure.

The system 200 includes a distributed ledger 208 that stores condition data generated by the electronic device 202 and communicated to the distributed ledger 208 via the network access nodes 206. The distributed ledger 208 is distributed over a combination of network nodes (e.g., peer nodes 102) that store condition data across other network nodes of a peer-to-peer network. The network nodes of the distributed ledger 208 can each replicate and store an identical copy of the condition data and update independently. Although shown in the network(s) 204, the distributed ledger 208 can be located anywhere to maintain a tamper-proof copy of condition data.

The system 200 includes a resale enabled marketplace manager node 210 that can mediate the flow of condition data from the electronic device 202 to the distributed ledger 208. In some embodiments, the resale enabled marketplace manager node 210 can include any number of server computers communicatively coupled to the electronic device 202 via the network access nodes 206. The resale enabled marketplace manager node 210 can include combinations of hardware and/or software to process condition data, perform functions, communicate over the network(s) 204, etc. For example, server computers of the resale enabled marketplace manager node 210 can include a processor, memory or storage, a transceiver, a display, operating system and application software, and the like. Other components, hardware, and/or software included in the system 200 that are well known to persons skilled in the art are not shown or discussed herein for brevity. Moreover, although shown as being included in the network(s) 204, the resale enabled marketplace manager node 210 can be located anywhere in the system 200 to implement the disclosed technology.

The resale enabled marketplace manager node 210 can provide the details regarding the authenticity of the excess products. The resale enabled marketplace manager node 210 can also control which types of parameters are monitored by the electronic device 202 and select events to report to the resale enabled marketplace manager node 210. In some embodiments, condition data could have values that depend on the estimated geographic location of the electronic device 202. The electronic device 202 can estimate its location from global positioning system (GPS) signals received from the satellites 212.

### Determining the Authenticity of Resale Products

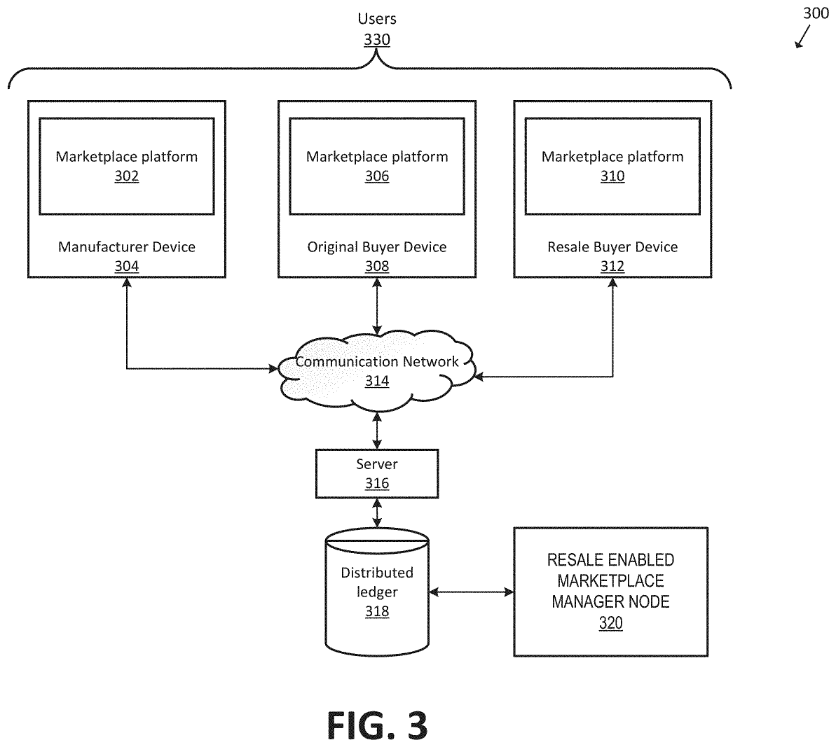

FIG. 3 is a block diagram of an environment in which the disclosed embodiments can be implemented. Users 330 are communicatively coupled to the distributed ledger 304 (e.g., distributed ledger 208) over communication network 314 via a server 316. Similarly, the distributed ledger 318 can communicated with resale enabled marketplace manager node 320. In some embodiments, the resale enabled marketplace manager node 320 is a network node of the distributed ledger 318.

The device 304, 308, and 312 can include a local storage that can store authentication data including lists of product details and product life cycle events. In some embodiments, the local storage includes non-volatile and/or volatile memory that can store the authentication data as needed and provide it to the resale enabled marketplace manager node 320. The product details are logged into the electronic devices 304, 308, and 312 and the corresponding data are stored as units of authentication data including type attribute and corresponding measure value captured at points in time. Likewise, product life cycle events are units of authentication data each with a type attribute and point in time when the event occurred. For example, manufacturer device 304 can be a personal computer located at the manufacturing facility. An employee at the manufacturing facility can use the manufacturer device 304 to log events that occur at manufacturing facility such as manufacturing milestones, order placement, and shipment. In another example, an electronic device (not shown) can be a device attached to the resale product and autonomously track details such as environmental conditions such as moisture, temperature, etc. In yet another example, an electronic device (not shown) can be the product that is being resold. For instance, the electronic device can be a smartphone which autonomously tracks a variety of details (e.g., location, time).

The electronic devices 304, 308, and 312 can push authentication data out according to a schedule or upon the occurrence of an event in the product like cycle. For example, the electronic devices 304, 308, and 312 can push authentication data out to the resale enabled marketplace manager node 320 when the product is shipped from the manufacturer's facility to the original buyer. In another example, the electronic devices 304, 308, and 312 can push the authentication data based on time period (e.g., weekly, monthly). In yet another example, the resale enabled marketplace manager node 320 can control when the authentication data is pulled from the electronic devices 304, 308, and 312 (e.g., on a schedule, on-demand).

The resale enabled marketplace manager node 320 can push authentication data to the distributed ledger 318, which stores the authentication data. The contents of the local storage (e.g. local storage of electronic devices 304, 308, and 312) and the ledger storage can be the same or different. For example, the resale enabled marketplace manager node 320 can process authentication data obtained from various electronic devices and push the processed authentication data for the distributed ledger 318. The ledger storage can store the authentication data in distinct section or containers represented based on, for example, respective electronic devices. In another example, the resale enabled marketplace manager node 320 can process the authentication data through a hashing function to further secure the authentication data stored at the distributed ledger 318. Overall, the ledger storage can include one or more records that store authentication data and corresponding timestamps for each source of information (e.g., electronic devices 304, 308, and 312). For example, a source of information can be an accelerometer attached to the resale product or in communication with electronic devices 304, 308, and 312. The accelerometer can collect timestamped data representing each time the product had been dropped. The ledger storage can include memories of peer nodes of the distributed ledger 318. The contents of the ledger storage can be accessible by the resale enabled marketplace manager node 320, the electronic devices 304, 308, and 312, or any third party that seeks to independently determine the authenticity of resale products. Accordingly, the contents of the local storage on board electronic devices 304, 308, and 312 and/or the ledger storage is the basis for determining the authenticity of resale products.

The local storage on board electronic devices 304, 308, and 312 can be optional because the electronic devices 304, 308, and 312 may not need to maintain authentication data in non-volatile memory. Instead, the electronic devices 304, 308, and 312 can instantaneously communicate authentication data to the resale manager node 320 in response to the generation of the authentication data. In some embodiments, the contents of the local storage can be accessed by the electronic devices 304, 308, and 312 independent of the resale enabled marketplace manager node 320 (e.g., while disconnected from any network). For example, the electronic devices 304, 308, and 312 can have monitoring functionality that is meant to alert the user of any risk-escalation events. The same data collected for the user can be communicated to the ledger storage as a third-party trusted repository of authentication data that can be subsequently used to verify the details (e.g., serial number) of the resale product. Overall, the ledger storage of distributed ledger 318 can include one or more records that store authentication data and corresponding timestamps for each event that occurs or is logged in the product life cycle.

In some embodiments, the marketplace platform 302, 306, and 310 can be implemented on electronic device 304, 308, and 312. For example, server 316 can implement at least a portion of the marketplace platform and can facilitate exchange of authenticity data between users 120 of the marketplace platform. The users 120 can utilize the marketplace platform 302, 306, and 310 as, for example, a smart application and/or website. In some embodiments, server 116, local storage, and/or external storage (not pictured) can store an executable file for generating the smart application. The executable file can also be at a different location (e.g., cloud-based storage). Further, each marketplace platform 302, 306 and 310 can be modified to fit the needs of each participant and be incorporated as a portal on a participant's parent website. For example, a manufacturer can have an existing website that customers have access to. The marketplace platform 304 can then be embedded as a portal (e.g., separate page) with, for example, a hyperlink on manufacturer's existing website.

In some embodiments, distributed ledger 318 can provide data to marketplace platform 302, 306, and 310. Thus, the data from the distributed ledger 318 may also be stored at various locations. For example, a participant in the life cycle such as a broker-dealer may want to locally store the data in the distributed ledger 318 that pertains to the products affiliated with the broker-dealer. Further, the broker-dealer may also want the data indicative of the marketplace platform stored locally. In other words, participants in the product life cycle can elect to store authenticity data in various places such as locally, externally, and/or in distributed ledger 318 and the participants can elect to partition the data in various ways such as by product, original customer, etc. For example, a buyer can elect to store data indicative of parts from manufacturer A in distributed ledger 318 and data indicative of parts from manufacturer B locally and their onsite data center.

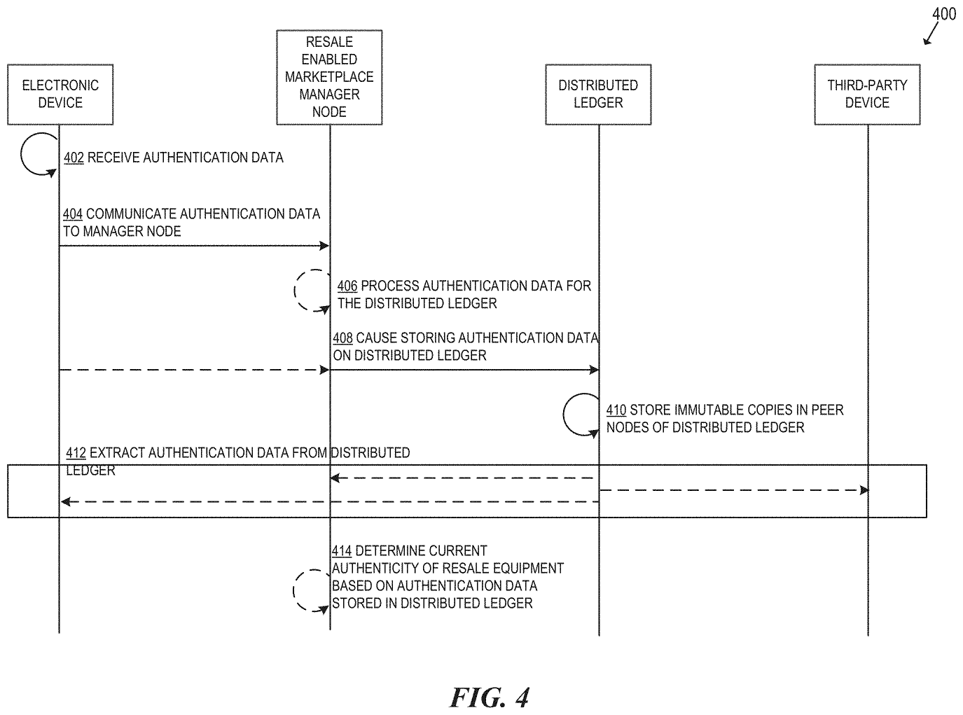

FIG. 4 is a flow diagram of a process 400 for determining the authenticity of a resale product. The process includes operations performed by a distributed network including electronic devices, a network of peer nodes that store a distributed ledger, and a resale enabled marketplace manager node that mediates collection of authentication data and storage of the authentication data on the distributed ledger. The resale enabled marketplace manager node can also communicate with multiple electronic devices that are in different locations and of different types. For example, the electronic device can be a personal computer at a manufacturing facility for logging events that occur at the manufacturing facility. Another electronic device may be a security cable tied to the resale product, that when broken indicates that the product has been used. Other such electronic devices may also be in communication with the resale manage node.

At 402, an electronic device receives authentication data. The authentication data includes units that are indicated of the authenticity of a resale product. The authenticity of the resale product can be based at least in part on a measured value of a data point. For instance, the data point can be occurrence of an event that affects the authenticity of the resale product (e.g., change in serial number). In another example, the electronic device can receive authentication data from each stage of a product life cycle. At the manufacturing stage, an employee of the manufacturer can log the completion of event during manufacturing (e.g., parts received, order received, shipping compete). In some cases, electronic device can pull data from the records of the manufacturing facility. For instance, the manufacturing can have its own record-keeping system, from which the electronic device can pull data. In another example, the electronic device can be in communication (e.g., via Bluetooth, wireless network) with devices placed in the environment near the resale product. For example, a GPS device can be placed on the resale product. The GPS can periodically send the location to the electronic device. In another example, the electronic device can receive data from the original buyer, such as data related to the original order (e.g., order receipt, shipping details).

At 404, the resale manage node obtains the authentication data over the network from the electronic device(s). The resale enabled marketplace manager node is a network node of a system that includes electronic devices and network nodes of the distributed ledger. At 406, the resale enabled marketplace manager node can optionally process the authentication data (e.g., filter, sort, encrypt). At 408, the electronic device or resale manage node can cause the distributed ledger to store the authentication data. At 410, the distributed ledger stores mostly immutable copies of the authentication data across other network notes of a peer-to-peer network. Specifically, each of the peer nodes replicates and stores an identical copy of the units of authentication data and updated independently in accordance with the principles of distributed ledger technologies. Examples of distributed ledgers include a public blockchain or a private blockchain.

At 412, the authentication data is extracted from the distributed ledger. In some embodiments, the resale enabled marketplace manager node, electronic device, or a third-party device can access the authentication information. The third-party can be, for example, the buyer of the resale product. At 414, the current authenticity of the resale product is determined based on the authentication information in the distributed ledger. For example, this can include flagging a discrepancy between the information in the distributed ledger and the listing for sale of the resale product. In another example, the marketplace platform may detect a discrepancy and not allow the posting to be public.

### Communication Session for Mutually Unsecure Entities to Exchange Blockchain-Secured Data

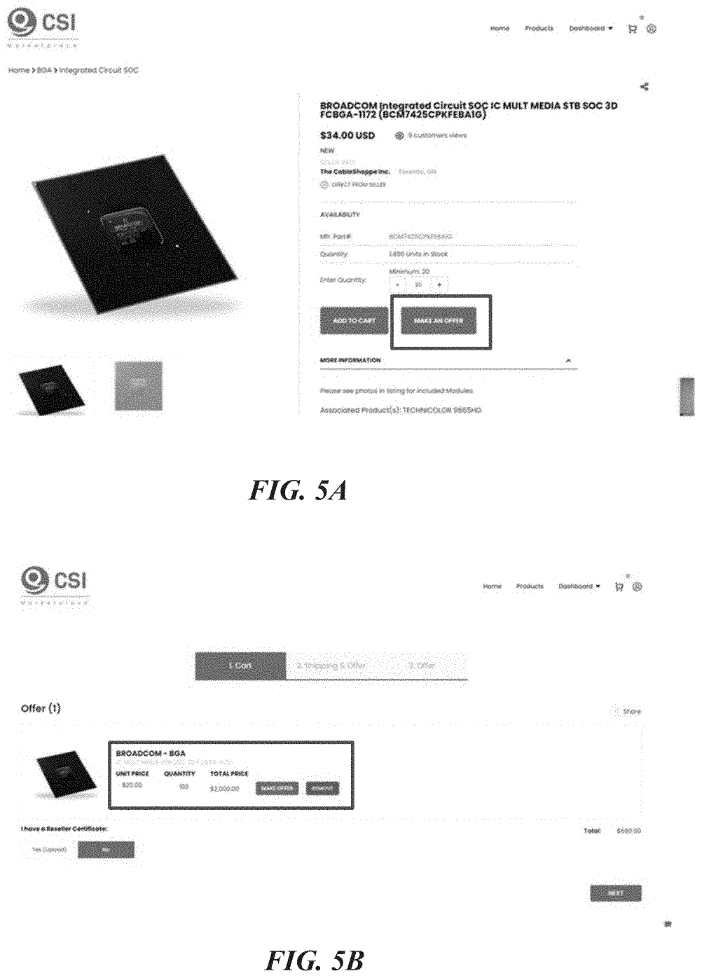

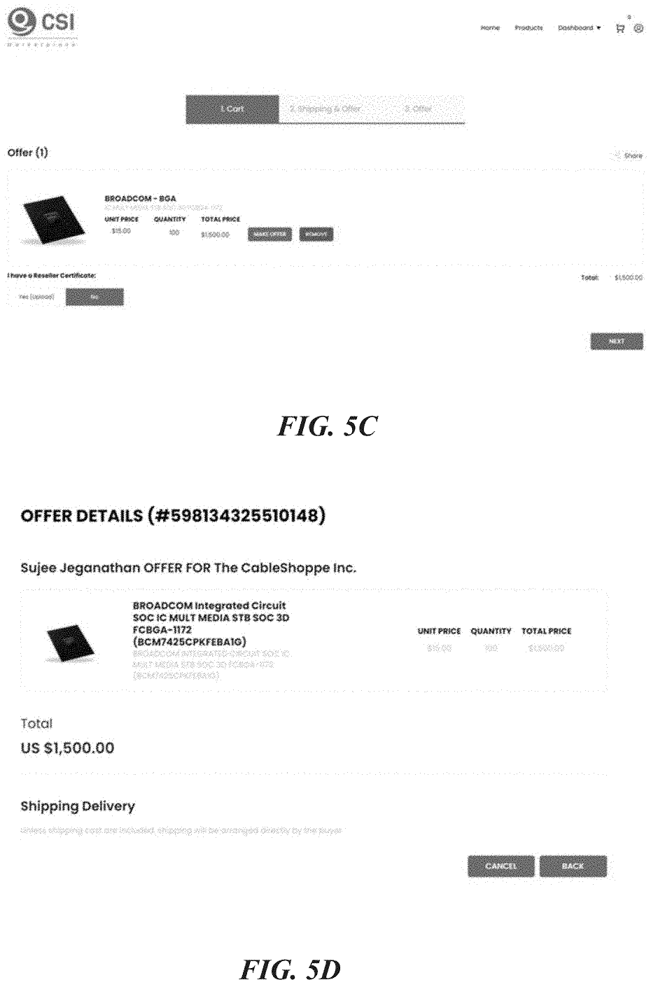

FIGS. 5A-D illustrate exemplary user interfaces for making an offer to purchase a resale product. In addition to the authenticity information and other information that can be stored on a distributed ledger (e.g., distributed ledger 318 in FIG. 3), transaction details regarding a resale can also be stored on the distributed ledger. Storing the resale details can include establishing a communication session or workflow procedure for exchanging communications between two or more devices used by entities involved in the transaction, and logging the data exchanged on the communication channels on the distributed ledger. A buyer can trigger the session or workflow procedure. Subsequently, the session or workflow procedure terminates once the transaction is, for example, agreed upon or rejected. Once the data is logged, a device of an entity can retrieve the data from the distributed ledger. Thus, each entity involved in the resale transaction can authenticate the data that is exchanged during the resale communication. In the following description, terms such as buyer, seller, reseller, and the like are used exemplary entities that can be involved in a resale transaction.

In some embodiments, the transaction data can include the details included in the posting for resale. For example, the posting for resale can be initiated by the original buyer of a product from the manufacturer. The posting can include the reseller's information, the number of units, the price per unit, the status of the unit (e.g., new or refurbished), photos of the units, the manufacturer part number, and other specification details of the units.

Once the buyer posts the offer for resale online, the details of the offer for resale are stored on the distributed ledger and, a buyer can view the offer for resale. A buyer can then decide to make an offer to buy the resale products. In some embodiments, the buyer can buy the resale products in accordance with the terms that the reseller requested. For example, a resale posting can offer a hundred widgets priced at $50 per widget. A buyer, upon viewing the resale post, can decide to buy all hundred budgets at $50 per widget.

Alternatively, the buyer can decide to make an offer to buy the widgets on different terms. The buyer can decide to vary the number of widgets, the price per widget, or both. To continue the scenario in the example above, the buyer can make an offer to buy fifty widgets at $50 per widget, rather than all hundred widgets. Or, the buyer can make an offer to buy all hundred widgets at $40 per widget. Or, the buyer can make an offer to buy fifty widgets and $40 per widget. In this manner, the buyer can make an offer based on the resale posting with different terms.

The actions performed by the buyer can also be logged in the distributed ledger. For example, if the buyer makes a counter offer to buy fifty widgets at $50 per widget, as in the example above, the terms of the counter offer can be stored in the distributed ledger. In addition to the terms, other data can also be logged in the distributed ledger which can help another party authenticate the counter offer. For example, other data can include the time and date that the counter offer was made.

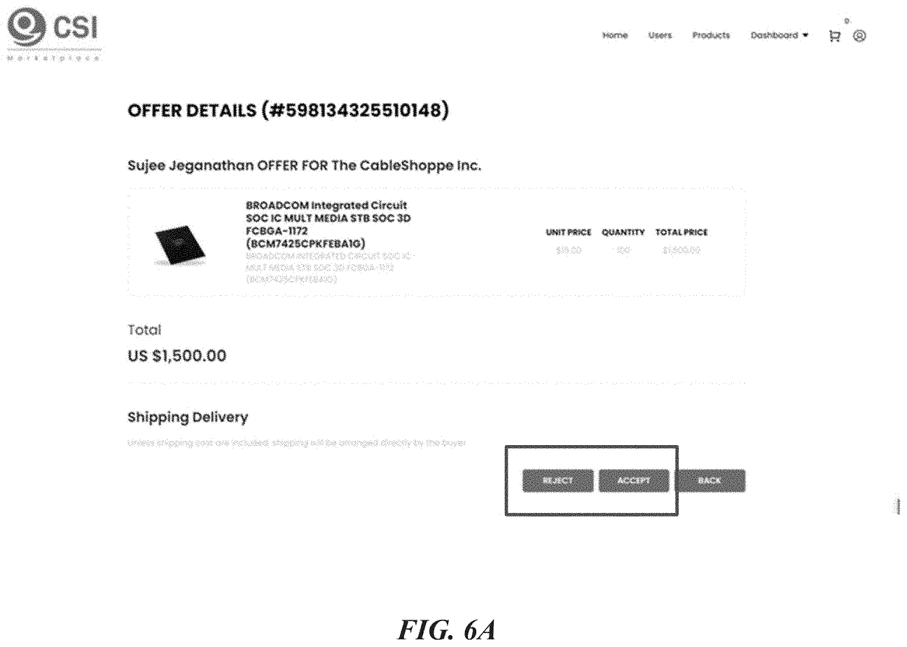

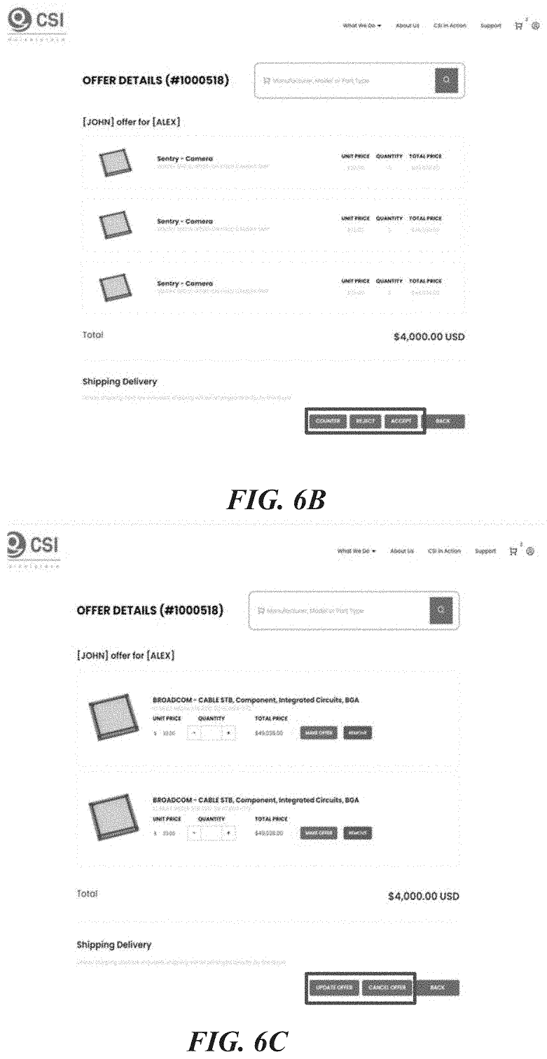

In return, the reseller can choose to accept, reject, or counter the offer. FIGS. 6A-C illustrate exemplary user interfaces from the reseller's perspective from which the seller can respond to an offer. If the reseller accepts the offer, the transaction is completed in accordance with the offer terms. If the reseller rejects the offer, the transaction is not completed. If the reseller decides to counter the offer, the reseller can adjust the terms. Similar to the offer to purchase, the reseller can counter by altering the number of units and/or the price per unit. After altering the terms, the reseller can update the offer. Similar to the actions performed by the buyer, the actions performed by the reseller can be logged on the distributed ledger such that another party (e.g., the buyer) can authenticate the reseller's actions.

In some embodiments, the actions of the buyer and/or reseller can be communicated to the other party via the marketplace platform or other means. The communication can occur on a communication channel between the two devices of the two parties. For example, when the buyer makes an offer, the reseller can receive an email with the terms of the offer. The email can also include a link to the reseller's profile on the marketplace platform (e.g., marketplace platform 306 in FIG. 3). Similarly, when the reseller accepts, rejects, or counters an offer, the buyer can also receive an email including the details of the reseller's action and a link to the transaction on the marketplace platform (e.g., marketplace platform 310 in FIG. 3).

As mentioned above, in addition to the transaction history of the product, the data from the interactions (e.g., accept, reject or counter) between the reseller and buyer can be stored on the distributed ledger. As described in FIG. 3, the buyer and reseller can interact with each other on the marketplace platform on their respective devices. The transactions that are facilitated by the marketplace platform are then stored on the distributed ledger. For example, when a reseller makes a posting for the resale of a product, the data from the posting can be stored on the distributed ledger. For example, the reseller's device can be connected via a communication network and a server to the distributed ledger. Thus, the data regarding the resale post can be transmitted for storage on the distributed ledger. Similarly, data from other actions the reseller and/or buyer on the marketplace platform can be stored on the distributed ledger.

From a potential buyer's perspective, the potential buyer can view the resale posting on the marketplace platform. Based on the actions of the potential buyer on the marketplace platform, the device can retrieve via the communication network and the server, the posting of the resale from the distributed ledger. The device can also retrieve other details from the transaction history of the product for resale such as the original sale details. From this, the potential buyer can view various details regarding the product for resale.

For instance, an original buyer of 1,000 widgets at $100 per widget can make a resale posting for the 800 of the widgets at $200 per widget. The posting can be published on the marketplace platform and stored on the distributed ledger. A potential buyer can, upon viewing the resale posting, request retrieval of other details of the product and/or posting from the distributed ledger. Thus, the potential buyer can trace the transaction details of the widget and view the terms of the original sale. Here, the potential buyer can see that the original sale was for the $100 per widget, and thus, can make a counter offer for below the original sale price.

In some embodiments, security measures can also be implemented, as mentioned above. In the example above, where the reseller made a posting for resale widget for $200, when the original sale price was $100, the marketplace platform can flag the posting as potentially erroneous. For example, prior the publishing the posting, the reseller may receive an error message indicating that the price is higher than the original sale price. The marketplace platform can execute the error message based on retrieving the prior transaction details of the widget and comparing it to the resale posting. When discrepancies are found, an error message can be populated. Similarly, a potential buyer may receive an error message when viewing a resale posting with discrepancies.

Accordingly, the interactions between a reseller and potential buyer can be stored on the distributed ledger. Each party can subsequently retrieve information from the distributed ledger to verify aspects and terms of a resale posting. In some embodiments, the marketplace platform can, based on a comparison of data stored on the distributed ledger and data from the resale posting, execute error messages indicating discrepancies.

### Resell Feature Embedded Within 3rd Party Platforms

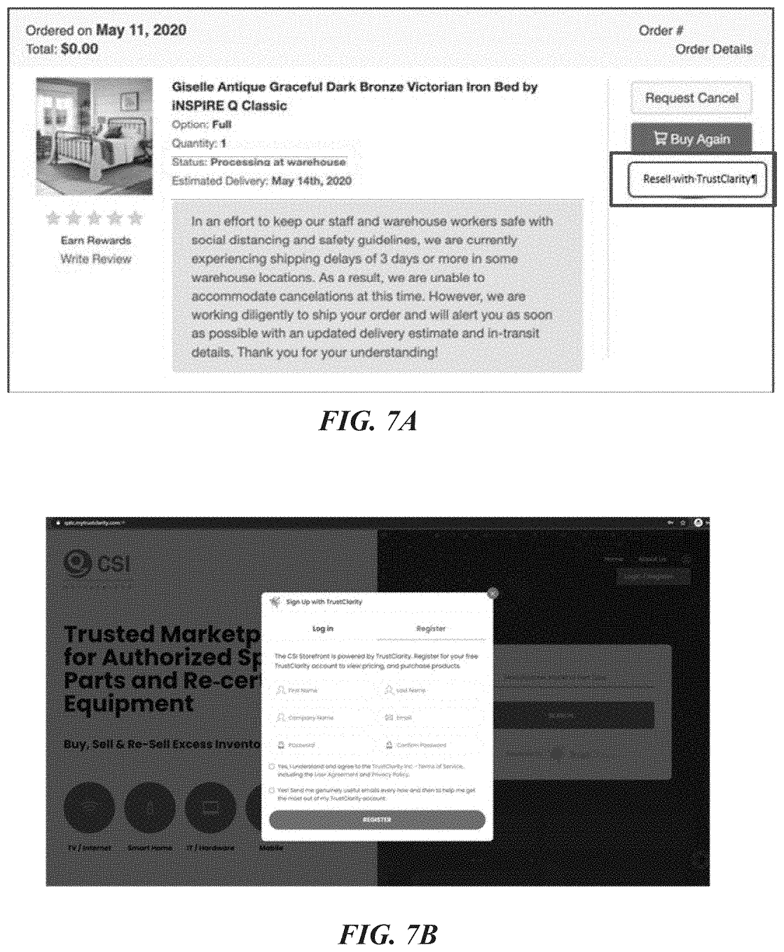

FIGS. 7A-B illustrate exemplary resell feature user interfaces embedded within a 3rd party platform. In particular, FIG. 7A illustrates the resell feature link embedded within the purchase history user interface on a 3rd party platform. FIG. 7B illustrates the registration interface once the resell feature is activated. The resell feature can be embedded into various pages of a 3rd party's platform. For example, the resell feature could be embedded within a purchase history page or on a details page of a product that a user has previously purchased. Once a user activates the resell feature, the user can be prompted to register or sign in to the marketplace platform. In some embodiments, once the resell feature is activated, the following graphical user interfaces can be overlaid on the 3rd party platform. The graphical user interfaces can include one or more successive pages that prompt a user to register and/or sign in, fill in details for a resale posting, or other actions needed to publish a resale post online. In some embodiments, after the user has registered or signed-in, the marketplace platform can retrieve details regarding the product from the 3rd party platform. To do so a communication channel can be established between, for example, the servers associated with the marketplace platform and the 3rd party platform. The details can include the product name, product category, description, purchase price, current location, original buyer's details, and other information needed to trace the chain of custody of the product.

The marketplace platform can use, for example, the product category to identify authorized resellers of the product. For instance, a user may activate the resell feature to resell a refurbished camera. Based on these retrieved details, the marketplace platform may identify authorized refurbished resellers of cameras. In some embodiments, the marketplace platform can, upon identifying authorized reseller, provide a list of these resellers to the user. The user can then elect one or more of the listed resellers and/or the marketplace platform on which their product will be listed. Once selected, the authorized reseller can receive a request for posting the product for resale. The authorized reseller can accept or reject the request. If accepted, the product can be listed on the authorized seller platform.

The data involved at all stages of the transaction, beginning from the activation of the resell feature on the 3rd party platform, can the logged on the distributed ledger. Thus, each entity involved in the transaction (e.g., authorized reseller) can retrieve the data for authentication purposes. Moreover, because the product details are retrieved directly from the original seller and logged on the distributed ledger, each entity can evaluate the authenticity of the data (e.g., offer for resale) without concern for the trustworthiness of the entities involved. In other words, each entity can trust the authenticity of the transaction details because of the data stored on the distributed ledger, rather than by the other entities involved.

Once the product is sold, each party can receive a portion of the proceeds. As described above, the rules for distribution of the proceeds can be established by, for example, a smart contract or terms saved on the distributed ledger. Thus, similar to other transactions on the marketplace platform, the details of transaction initiated from a 3rd party platform can also be stored on the distributed ledger. For instance, the product details retrieved from the 3rd party platform can be stored on the distributed ledger. These details can then be pulled by authorized resellers when they are deciding whether to accept or reject the request to the post the listing on their platforms.

### Exemplary System

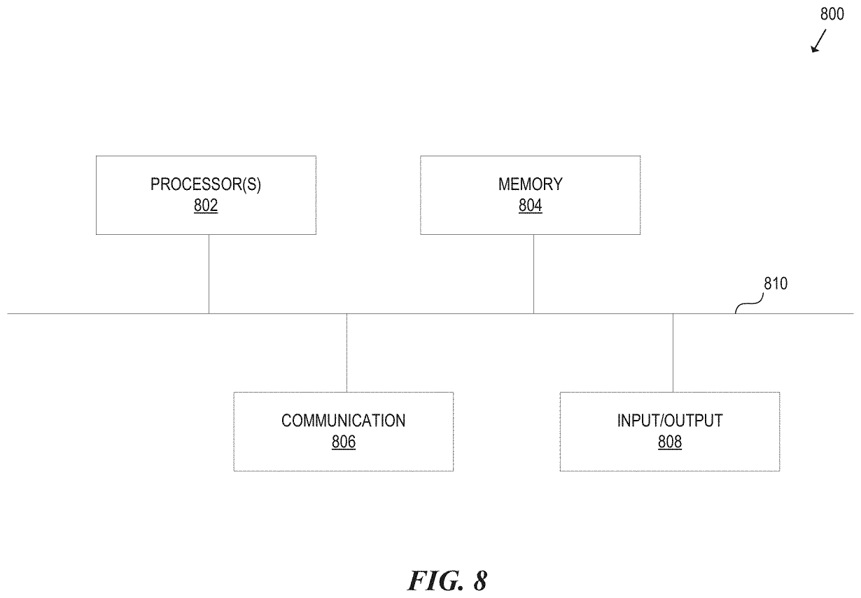

FIG. 8 is a block diagram that illustrates an example of a processing system 800 in which at least some operations described herein can be implemented. The processing system 800 represents a system that can run any of the methods/algorithms described herein. For example, any network access device (e.g., electronic device 202, 304, 308, or 312) or network component (access node 206-1 or resale enabled marketplace manager node 210) can include or be part of a processing system 800. The processing system 800 can include one or more processing devices, which can be coupled to each other via a network or multiple networks. A network can be referred to as a communication network or telecommunications network.

In the illustrated embodiment, the processing system 800 includes one or more processors 802, memory 804, a communication device 806, and one or more input/output (I/O) devices 808, all coupled to each other through an interconnect 810. The interconnect 810 can be or include one or more conductive traces, buses, point-to-point connections, controllers, adapters and/or other conventional connection devices. Each of the processor(s) 802 can be or include, for example, one or more general-purpose programmable microprocessors or microprocessor cores, microcontrollers, application-specific integrated circuits (ASICs), programmable gate arrays, or the like, or a combination of such devices.

The processor(s) 802 control the overall operation of the processing system 800. Memory 804 can be or include one or more physical storage devices, which can be in the form of random-access memory (RAM), read-only memory (ROM) (which can be erasable and programmable), flash memory, miniature hard disk drive, or other suitable type of storage device, or a combination of such devices. Memory 804 can store data and instructions that configure the processor(s) 802 to execute operations in accordance with the techniques described above. The communication device 806 can be or include, for example, an Ethernet adapter, cable modem, Wi-Fi adapter, cellular transceiver, Bluetooth transceiver, or the like, or a combination thereof. Depending on the specific nature and purpose of the processing system 800, the I/O devices 808 can include devices such as a display (which can be a touch screen display), audio speaker, keyboard, mouse or other pointing devices, microphone, camera, etc.

While processes or blocks are presented in a given order, alternative embodiments can perform routines having steps or employ systems having blocks, in a different order, and some processes or blocks can be deleted, moved, added, subdivided, combined and/or modified to provide alternative or sub-combinations, or can be replicated (e.g., performed multiple times). Each of these processes or blocks can be implemented in a variety of different ways. In addition, while processes or blocks are at times shown as being performed in series, these processes or blocks can instead be performed in parallel or can be performed at different times. When a process or step is “based on” a value or a computation, the process or step should be interpreted as based at least on that value or that computation.

Software or firmware to implement the techniques introduced here can be stored on a machine-readable storage medium and can be executed by one or more general-purpose or special-purpose programmable microprocessors. A “machine-readable medium”, as the term is used herein, includes any mechanism that can store information in a form accessible by a machine (a machine can be, for example, a computer, network device, cellular phone, personal digital assistant (PDA), manufacturing tool, any device with one or more processors, etc.). For example, a machine-accessible medium includes recordable/non-recordable media (e.g., read-only memory (ROM), random-access memory (RAM), magnetic disk storage media, optical storage media, flash memory devices), etc.

Note that any and all of the embodiments described above can be combined with each other, except to the extent that it may be stated otherwise above, or to the extent that any such embodiments might be mutually exclusive in function and/or structure. Although the present invention has been described with reference to specific exemplary embodiments, it will be recognized that the invention is not limited to the embodiments described but can be practiced with modification and alteration within the spirit and scope of the disclosed embodiments. Accordingly, the specification and drawings are to be regarded in an illustrative sense rather than a restrictive sense.

Physical and functional components (e.g., devices, engines, modules, and data repositories) associated with processing system 800 can be implemented as circuitry, firmware, software, other executable instructions, or any combination thereof. For example, the functional components can be implemented in the form of special-purpose circuitry, in the form of one or more appropriately programmed processors, a single board chip, a field-programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer-readable data storage. The tangible storage memory can be a volatile or non-volatile memory. In some embodiments, the volatile memory can be considered “non-transitory” in the sense that it is not a transitory signal. Memory space and storage described in the figures can be implemented with the tangible storage memory as well, including volatile or non-volatile memory.

Each of the functional components can operate individually and independently of other functional components. Some or all of the functional components can be executed on the same host device or on separate devices. The separate devices can be coupled through one or more communication channels (e.g., wireless or wired channel) to coordinate their operations. Some or all of the functional components can be combined as one component. A single functional component can be divided into sub-components, each sub-component performing separate method steps or a method step of the single component.

In some embodiments, at least some of the functional components share access to a memory space. For example, one functional component can access data accessed by or transformed by another functional component. The functional components can be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implement a portion of the functional components). Other arrays, systems, and devices described above can include additional, fewer, or different functional components for various applications.

Aspects of the disclosed embodiments may be described in terms of algorithms and symbolic representations of operations on data bits stored in memory. These algorithmic descriptions and symbolic representations generally include a sequence of operations leading to the desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above-detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes, message/data flows, or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges. Those skilled in the art will also appreciate that the actual implementation of a database can take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements and acts of the various embodiments described above can be combined to provide further embodiments.

These and other changes can be made to the invention in light of the above Detailed Description. While the above description describes certain embodiments of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as embodied in a computer-readable medium, other aspects can likewise be embodied in a computer-readable medium. Accordingly, the inventors reserve the right to add additional claims after filing the application to pursue such additional claim forms for other aspects of the technology.

1. A method comprising:
collecting authenticity data that are indicative of events during phases of a product,
wherein the authenticity data is time-stamped;
causing storage of the authenticity data in a blockchain-secured repository that is immutable and spread across network nodes of a peer-to-peer network,
wherein each network node stores a substantially identical copy of the authenticity data and updates independent of any other network node,
and wherein the substantially identical copy of the authenticity data is hashed with pseudorandom data;
receiving a request to make public a listing of the product on a platform, the platform being communicatively coupled to the blockchain-secured repository,
wherein the request includes at least a unique identifier of the product;
parsing, based on the part number, the substantially identical copy of the authenticity data stored in the blockchain-secured repository;
determining that the listing does not include data that contradicts the substantially identical copy of the authenticity data stored in the blockchain-secured repository; and
causing the listing to become public.

2. A method comprising:
receiving an input by a user to purchase a product posted on an online platform, the purchase being conditioned on a change proposed by the user an indicated in the input;
in response to receiving the input, establishing a communication session between the user and an owner of the product; and
causing storage of at least the changed proposed by the user in a blockchain-secured repository.

3. A method comprising:
causing display of a link associated with a product, the link being integrated into an online platform;
upon activation of the link, establishing a first communication channel between the online platform and a blockchain-secured repository;
retrieving, through the first communication channel, data related to a chain of custody of the product and to a specification of the product;
causing storage of the data in the blockchain-secured repository;
causing display of a first graphical user interface including prompts for identification information;
upon receiving the identification information, parsing the data;
identifying, based on parsing the data, an entity associated with the product;
establishing a second communication channel with the entity; and
transmitting a request to make public a listing of the product on a platform of the entity.
